(19) United States
(12) Patent Application Publication
(10) Pub. No.: US 2006/0122953 A1
(43) Pub. Date: Jun. 8, 2006

(54) Method for building a model of a multi-phase PWM-based converter

(75) Inventors: Yong-Zhao Huang, Shen-Zhen (CN); Yun Li, Shen-Zhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/283,286

(22) Filed: Nov. 17, 2005

(30) Foreign Application Priority Data
Nov. 19, 2004 (CN) 200410052381.4

(51) Int. Cl. G06N 3/06

(52) U.S. Cl. 706/35

(57) ABSTRACT

A method for building a model of a multi-phase PWM-based converter is disclosed. The method includes the steps of: defining circuit diagrams and electronic characteristics of a circuit of the multi-phase PWM-based converter; defining configuration of a model of the multi-phase PWM-based converter, and defining characteristics of the model according to the circuit diagrams and the electronic characteristics; and building the model of the multi-phase PWM-based converter.

### BACKGROUND OF THE INVENTION

1. Field of the Invention

The present invention relates to a method for building a model of a multi-phase PWM-based converter.

2. General Background

In recent years, with the development of performance of CPUs, it's urgent in demands for converters which have lower output voltage and higher output current. Furthermore, heat performance, electro magnetic interference, and load transient of the converters need to be improved urgently. Conventional single-phase PWM (pulse width modulation) based converters suffer from high total harmonic distortion and poor power factor. On the contrary, multi-phase PWM-based converters solve all problems that the CPUs bring.

Usually, the multi-phase PWM-based converters, CPU, and other loads are assembled in a same printed circuit board. It's discommodious to complete aforehand performance evaluation experiments. Then it's more and more important to utilize simulation mode to evaluate performances of the multi-phase PWM-based converters. Cadence OrCAD Pspice (hereinafter “Pspice”) is a widely used simulation software during the period of designing the multi-phase PWM-based converters. A main problem solved by the Pspice software is accuracy and integrality of models' parameters of the multi-phase PWM-based converters.

However, accurate Pspice models of the multi-phase PWM-based converters are very difficult to design because of complicated inner circuit configuration of the multi-phase PWM-based converters.

Therefore, what is needed is a method for building a model of a multi-phase PWM-based converter, by which the users can directly put the model into real circuits for simulation.

### SUMMARY

A method for building a model of a multi-phase PWM-based converter in accordance with a preferred embodiment of the present invention is provided. The method comprises the steps of: defining circuit diagrams and electronic characteristics of a circuit of a multi-phase PWM-based converter; defining configuration of the model, and defining characteristics of the model according to the defined circuit diagrams and the electronic characteristics; and building the model of the multi-phase PWM-based converter.

Furthermore, a method for building a model of a multi-phase PWM-based DC/DC converter is provided. The method comprises the steps of: deconstructing a circuit of the multi-phase PWM-based DC/DC converter into a main PWM circuit and an assistant circuit; deconstructing the main circuit and the assistant circuit into a plurality of sub-circuits according to their functions; building models of the sub-circuits, and defining a configuration of a model of the multi-phase PWM-based DC/DC converter; and incorporating models of all the sub-circuits into the model of the multi-phase PWM-based DC/DC converter according to the configuration.

Other advantages and novel features of the present invention will be drawn from the following detailed description of a preferred embodiment and preferred method with the attached drawings, in which:

### BRIEF DESCRIPTION OF THE DRAWINGS

FIG. 1 is a schematic diagram of a single-phase PWM-based IC in accordance with a preferred embodiment of the present invention;

FIG. 2 is a flowchart of a preferred method for building a model of a multi-phase PWM-based converter;

FIG. 3 is a flowchart of a preferred method for building a model of a multi-phase PWM-based DC/DC converter;

FIG. 4 is a schematic diagram of structure of an assistant circuit of FIG. 3; and

FIG. 5 is schematic diagram of structure of a main PWM circuit of FIG. 3.

### DETAILED DESCRIPTION OF THE PREFERRED EMBODIMENTS

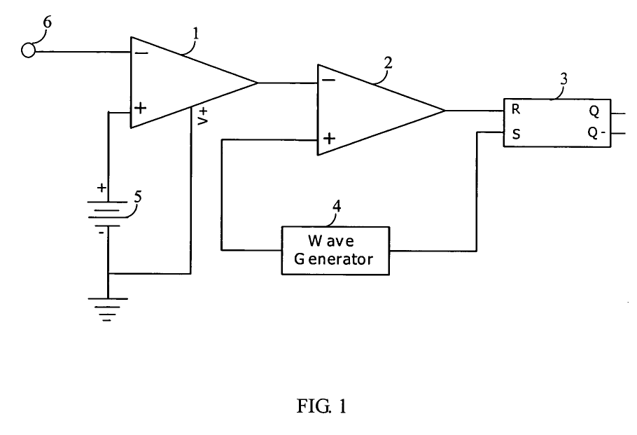

FIG. 1 is a simple schematic diagram of a single-phase PWM-based IC (integrated circuit) in accordance with a preferred embodiment of the present invention. The single-phase PWM-based IC comprises a voltage error amplifier 1, a PWM comparator 2, an RS (reset and set) trigger 3 and a wave generator 4.

The voltage error amplifier 1 has four ports. The four ports include a negative input port, a positive input port, a V+ port, and an output port. The negative input port of the voltage error amplifier 1 inputs a feedback voltage 6. The positive input port is connected with a positive port of a reference voltage 5. The V+ port is directly connected with a ground line. The output port is connected with a negative input port of the PWM comparator 2. A positive input port of the PWM comparator 2 is connected with an S input port of the RS trigger 3 through the wave generator 4. An output port of the PWM comparator 2 is connected with an R input port of the RS trigger 3. The RS trigger 3 outputs signals through a Q output port or a Q− output port. The positive input port of the PWM comparator 2 receives saw-tooth waves from the wave generator 4 for modulating pulse width. The S input port of the RS trigger 3 receives square waves from the wave generator 4 for triggering the RS trigger 3.

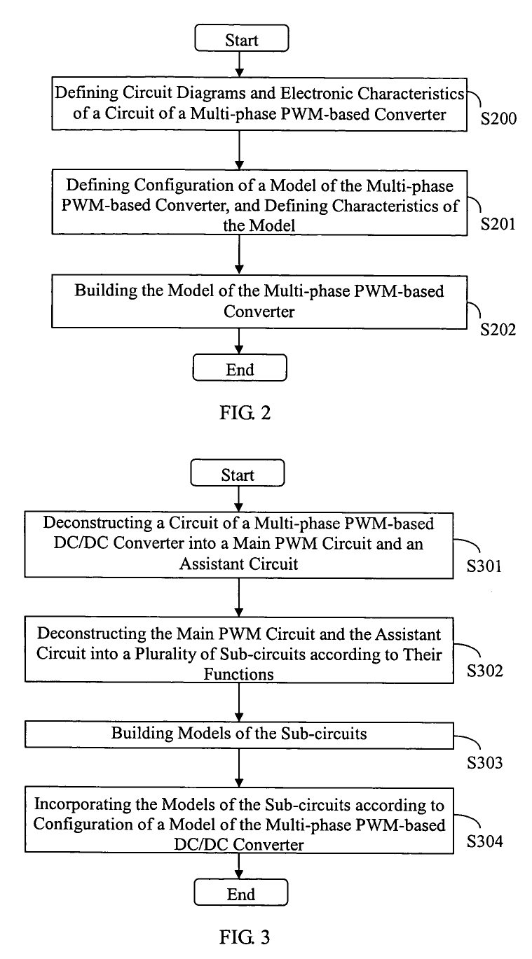

FIG. 2 is a flow chart of a preferred method for building a model of a multi-phase PWM-based converter. In step S200, a user defines circuit diagrams and electronic characteristics of a circuit of the multi-phase PWM-based converter by a computing device. The circuit diagrams are defined according to their functions. In step S201, the user defines configuration of the model, and defines characteristics of the model according to the defined circuit diagrams and the electronic characteristics. In step S202, the computing device builds the model of the multi-phase PWM-based converter according to the configuration and the characteristics of the model. After the model is successfully built, the user can put the model into a circuit for simulation, and optimize the model by comparing simulation results with testing results of the circuit.

FIG. 3 is a flow chart of a preferred method for a building a model of a multi-phase PWM-based DC/DC converter. In step S301, a user deconstructs a circuit of the multi-phase PWM-based DC/DC converter into a main PWM circuit and an assistant circuit by a computing device. Then, the user defines electronic characteristics of the main PWM circuit and the assistant circuit. In step 302, the user deconstructs the main PWM circuit and the assistant circuit into a plurality of sub-circuits respectively according to their functions, and defines electronic characteristics of each sub-circuit. In step S303, the computing device builds a model for each sub-circuit according to its electronic characteristics, and defines configuration of the model of the multi-phase PWM-based DC/DC converter. In step S304, the computing device incorporates models of all the sub-circuits into the model of the multi-phase PWM-based DC/DC converter according to the configuration.

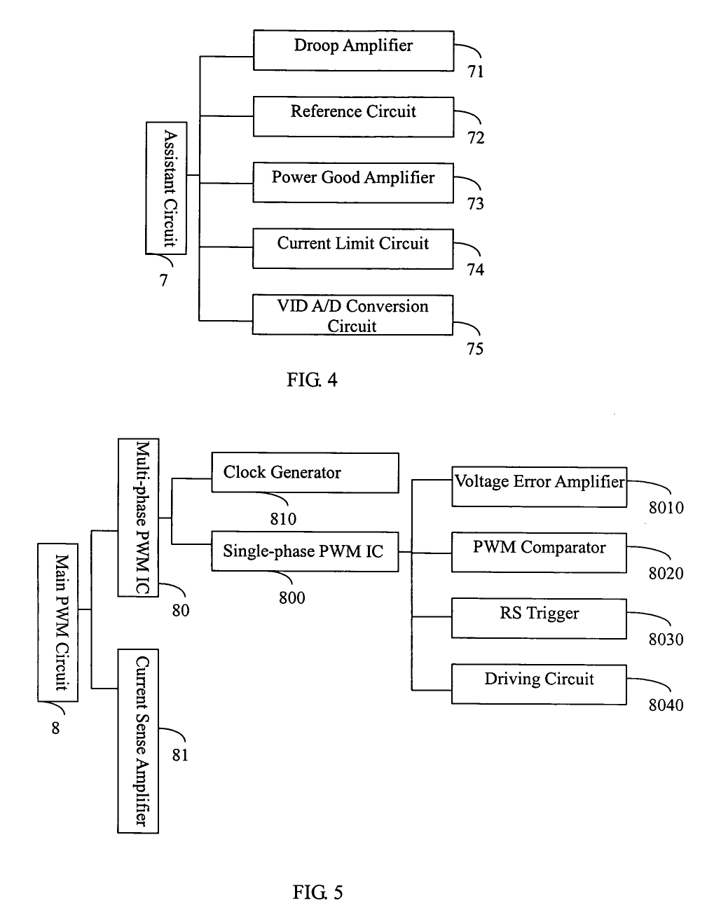

FIG. 4 is a schematic diagram of structure of the assistant circuit of FIG. 3. The assistant circuit comprises a droop amplifier 71, a reference circuit 72, a power good amplifier 73, a current limit circuit 74, and a voltage identification analog/digital (VID A/D) conversion circuit 75. The droop amplifier 71 is used for protecting over voltage and under voltage. The reference circuit 72 is used for providing a reference voltage for the voltage error amplifier 1. The power good amplifier 73 is used for outputting power good signals denoting that the circuit of the multi-phase PWM-based DC/DC converter begins to work. The current limit circuit 74 provides current protection functions. The VID A/D conversion circuit 75 is used for converting analog signals t to digital signals, or converting digital signals to analog signals.

FIG. 5 is a schematic diagram of structure of the main PWM circuit of FIG. 3. The main PWM circuit comprises a multi-phase PWM IC 80 and a current sense amplifier 81. The current sense amplifier 81 is used for assuring that output currents of all conversion channels are average. The multi-phase PWM IC 80 comprises a plurality of single-phase PWM ICs 800 (only one shown) and a clock generator 810. Each single-phase PWM IC 800 comprises a voltage error amplifier 8010, a PWM comparator 8020, an RS trigger 8030, and a driving circuit 8040.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A computer-based method for building a model of a multi-phase PWM-based converter, the method comprising the steps of:
defining circuit diagrams and electronic characteristics of a circuit of the multi-phase PWM-based converter;
defining configuration of the model, and defining characteristics of the model according to the circuit diagrams and the electronic characteristics; and
building the model of the multi-phase PWM-based converter.

2. A computer-based method for building a model of a multi-phase PWM-based DC/DC converter, the method comprising the steps of:
deconstructing a circuit of the multi-phase PWM-based DC/DC converter into a main PWM circuit and an assistant circuit;
deconstructing the main circuit and the assistant circuit into a plurality of sub-circuits respectively according to their functions, and defining electronic characteristics of each sub-circuit;
building a model of each sub-circuit, and defining configuration of the model of the multi-phase PWM-based DC/DC converter; and
incorporating models of the sub-circuits into the model of the multi-phase PWM-based DC/DC converter according to the configuration.

3. The method according to claim 2, wherein the assistant circuit comprises a droop amplifier, a reference circuit, a power good amplifier, a current limit circuit, and a voltage identification analog/digital conversion circuit.

4. The method according to claim 2, wherein the main PWM circuit comprises a multi-phase PWM integrated circuit and a current sense amplifier.

5. The method according to claim 4, wherein the multi-phase PWM integrated circuit comprises a clock generator and a plurality of single-phase PWM integrated circuits.

6. The method according to claim 5, wherein each of the single-phase PWM integrated circuits comprises a voltage error amplifier, a PWM comparator, an RS trigger and a driving circuit.

7. A method for building a simulative model of a multi-phase pulse-width-modulation (PWM) based converter, comprising the steps of:
retrieving a physical circuit of a multi-phase PWM-based converter;
functionally deconstructing said circuit into a plurality of sub-circuits each of which has an electrical function independent from others of said plurality of sub-circuits;
defining electronic characteristics of said each of said plurality of sub-circuits;
defining configuration of a simulative model for said each of said plurality of sub-circuits while establishing said model according to said electronic characteristics of said each of said plurality of sub-circuits; and
incorporating said model of said each of said plurality of sub-circuits with other models of said others of said plurality of sub-circuits so as to acquire a complete simulative model for said multi-phase PWM-based converter.

8. The method according to claim 7, further comprising the step of deconstructing said circuit into a main PWM circuit and an assistant circuit before further deconstructing said main PWM circuit and said assistant circuit into said plurality of sub-circuits respectively.
